(19) United States
(12) Patent Application Publication
(10) Pub. No.: US 2024/0361455 A1
(43) Pub. Date: Oct. 31, 2024

(54) CONTROL DEVICE AND A CONTROL METHOD FOR A MULTI-RANGING CAMERA

(71) Applicant: JVCKENWOOD Corporation, Yokohama-shi (JP)

(72) Inventor: Toshihide KOBAYASHI, Yokohama-shi (JP)

(21) Appl. No.: 18/645,317

(22) Filed: Apr. 24, 2024

(30) Foreign Application Priority Data
Apr. 25, 2023 (JP) 2023-071641

(51) Int. Cl. G01S 17/08; G01S 7/48; G01S 17/89; H04N 23/69

(52) U.S. Cl. CPC G01S 17/08; G01S 7/4802; G01S 17/89; H04N 23/69

(57) ABSTRACT

An arithmetic unit calculates a distance from each ranging camera of a plurality of ranging cameras arranged to surround a subject to a center of the subject. One of the plurality of ranging cameras is set as a reference ranging camera. The zoom controller controls a focal length of the zoom when the ranging camera other than the reference ranging camera photographs the subject, thereby controlling the zoom of the ranging cameras other than the reference ranging camera to a focal length by multiplying the focal length of the zoom when the reference ranging camera photographs the subject by a value obtained by dividing the distance from the reference ranging camera to the center of the subject by a distance from the ranging camera other than the reference ranging camera to the center of the subject.

### CROSS REFERENCE TO RELATED APPLICATIONS

This application is based upon and claims the benefit of priority under 35U.S.C. § 119 from Japanese Patent Application No. 2023-071641 filed on Apr. 25, 2023, the entire contents of which are incorporated herein by reference.

### BACKGROUND

The present disclosure relates to a control device and a control method for a multi-ranging camera.

A volumetric image generation device generates a volumetric image which is a three-dimensional model of the subject by photographing a subject at an angle of 360 degrees by a plurality of ranging cameras.

### SUMMARY

When the distances between a subject and each of ranging cameras are different from one another, the angle of view for each of the ranging cameras will not be consistent when photographing a subject, so amounts of point clouds of images photographed by each of the ranging cameras vary. Similarly, if the ranging cameras are provided with a zoom lens and each ranging camera zooms with a different zoom amount, the amounts of point clouds of the images photographed by each ranging camera vary. When a volumetric image is generated by synthesizing images photographed by a plurality of ranging cameras having amounts of point clouds that are different from one another, it may result in a sense of visual discomfort.

If a subject is photographed in a dedicated studio called a volumetric studio in which distances between a subject and each of ranging cameras are strictly controlled, the amounts of point clouds in the images photographed by each of the ranging cameras will coincide. However, it is expensive to rent a dedicated studio and it is not easy to photograph the subject.

A first aspect of one or more embodiments provides a control device for a multi-ranging camera including: an arithmetic unit configured to calculate a distance from each ranging camera of a plurality of ranging cameras arranged to surround a subject and including a zoom lens to a center of the subject; and a zoom controller configured to set one of the plurality of ranging cameras as a reference ranging camera, and to control a zoom of the ranging cameras other than the reference ranging camera so that a focal length of a zoom when the ranging cameras other than the reference ranging camera photograph the subject is set to a focal length obtained by multiplying the focal length of the zoom when the reference ranging camera photographs the subject by a value obtained by dividing a distance from the reference ranging camera to the center of the subject by a distance from the ranging cameras other than the reference ranging camera to the center of the subject.

A second aspect of one or more embodiments provides a control method for multi-ranging camera including: by means of a computing device that controls a plurality of ranging cameras arranged to surround a subject, calculating a distance from each ranging camera of the plurality of ranging cameras to a center of the subject; setting one of the plurality of ranging cameras as a reference ranging camera; and controlling a zoom of the ranging cameras other than the reference ranging camera so that a focal length of a zoom when the ranging cameras other than the reference ranging camera photograph the subject is set to a focal length obtained by multiplying the focal length of the zoom when the reference ranging camera photographs the subject by a value obtained by dividing a distance from the reference ranging camera to the center of the subject by a distance from the ranging cameras other than the reference ranging camera to the center of the subject.

### BRIEF DESCRIPTION OF THE DRAWINGS

FIG. 1 is a diagram illustrating a plurality of ranging cameras arranged to surround a subject.

FIG. 2 is a conceptual diagram illustrating point cloud data generated by photographing the subject with the same zoom amount by the plurality of ranging cameras shown in FIG. 1.

FIG. 3 is a diagram illustrating a state in which a controller device of the multi-ranging camera according to a first embodiment measures a distance between the ranging cameras opposed to each other in the plurality of ranging cameras.

FIG. 4A is a flowchart illustrating a partial process in which a control device of the multi-ranging camera according to a first embodiment measures the distance between the ranging cameras opposed to each other.

FIG. 4B is a flowchart illustrating a partial process following FIG. 4A in which the control device of the multi-ranging camera according to a first embodiment measures the distance between the ranging cameras opposed to each other.

FIG. 5A is a plan view of a lens barrel of a ranging camera viewed from the front.

FIG. 5B is a plan view of a lens cap attached to a lens of a ranging camera.

FIG. 5C is a plan view of a lens cap with a white center and a black periphery attached to the lens of the ranging camera.

FIG. 6 is a partial perspective view of the lens barrel of the ranging camera to which the lens cap is attached.

FIG. 7 is a conceptual diagram of a near-infrared image generated by photographing a ranging camera opposed to one of a plurality of ranging cameras.

FIG. 8 is a diagram illustrating a luminance level of near-infrared light in a horizontal direction at a vertical position through a lens cap in a near-infrared image shown in FIG. 7.

FIG. 9 is a diagram illustrating a plurality of ranging cameras photographing a subject.

FIG. 10 is a view illustrating in detail the ranging to a subject by the ranging cameras.

FIG. 11A is a flowchart illustrating a partial process in which a control device of a multi-ranging camera according to a second embodiment measures a distance to two adjacent ranging cameras.

FIG. 11B is a flowchart illustrating a partial process following FIG. 11A in which the control device of the multi-ranging camera according to a second embodiment measures the distance to two adjacent ranging cameras.

FIG. 11C is a flowchart illustrating a partial process following FIG. 11B in which the control device of the multi-ranging camera according to a second embodiment measures the distance to two adjacent ranging cameras.

FIG. 11D is a flowchart illustrating a partial process following FIG. 11C in which the control device of the multi-ranging camera according to a second embodiment measures the distance to two adjacent ranging cameras.

FIG. 11E is a flowchart illustrating a partial process following FIG. 11D in which the control device of the multi-ranging camera according to a second embodiment measures the distance to two adjacent ranging cameras.

FIG. 12 is a diagram conceptually illustrating a near-infrared image generated by photographing two adjacent ranging cameras by one of the plurality of ranging cameras.

FIG. 13A is a diagram illustrating point cloud coordinates in the center of a lens cap extracted by the control device of the multi-ranging camera according to a second embodiment while a ranging camera 1A is photographing the ranging cameras 1B and 1D.

FIG. 13B is a diagram illustrating point cloud coordinates in the center of a lens cap extracted by the control device of the multi-ranging camera according to a second embodiment while the ranging camera 1B is photographing the ranging cameras 1A and 1C.

FIG. 13C is a diagram illustrating point cloud coordinates in the center of a lens cap extracted by the control device of the multi-ranging camera according to a second embodiment while the ranging camera 1C is photographing the ranging cameras 1B and 1D.

FIG. 13D is a diagram illustrating point cloud coordinates in the center of a lens cap extracted by the control device of the multi-ranging camera according to a second embodiment while the ranging camera 1D is photographing the ranging cameras 1A and 1C.

FIG. 14 is a diagram illustrating a coordinate system of the ranging camera 1B as viewed from the ranging camera 1A.

FIG. 15 is a diagram modeled on FIG. 14, illustrating a relationship between a direction of an axis of the ranging camera 1A and a direction of an axis of the ranging camera 1B.

FIG. 16 is a diagram illustrating a field of view in which the control device of the multi-ranging camera according to a second embodiment determines the center of the subject.

### DETAILED DESCRIPTION

Hereinafter, a control device and a control method of a multi-ranging camera according to each embodiment will be described with reference to the accompanying drawings.

### First Embodiment

The control device and control method of the multi-ranging camera according to a first embodiment are suitable for use when the subjects photographed by the plurality of ranging cameras can be temporarily moved when adjusting each ranging camera.

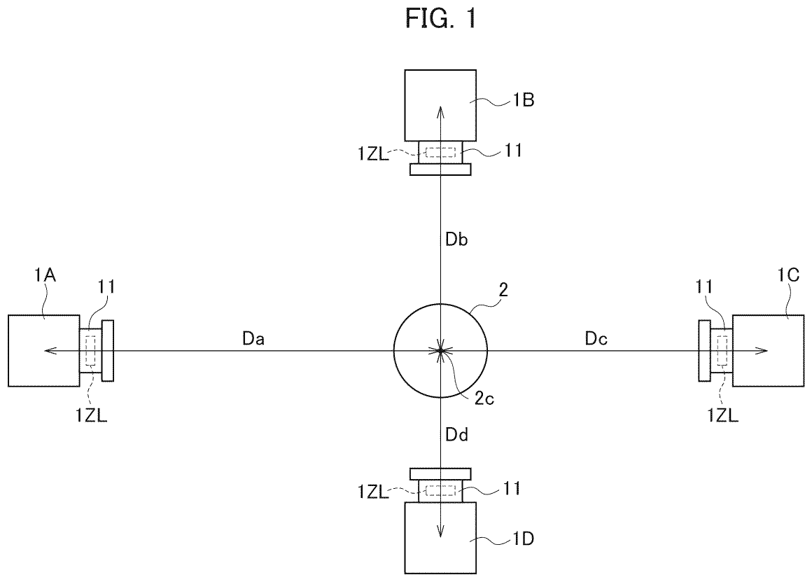

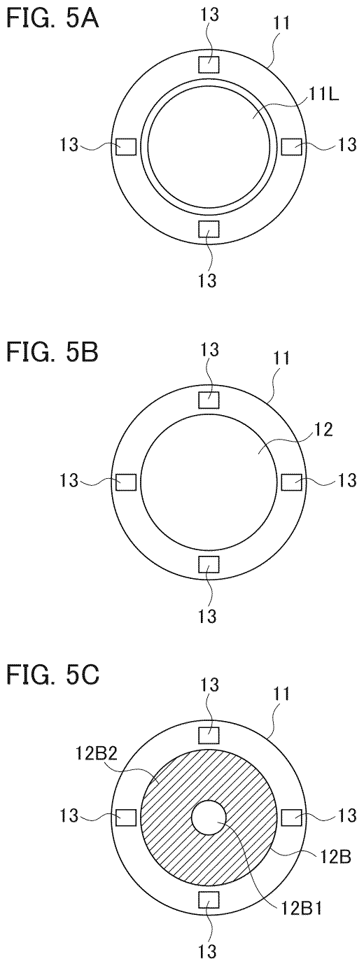

In FIG. 1, ranging cameras 1A to 1D are arranged to surround a subject 2. The ranging cameras 1A to 1D have the same performance. The ranging cameras 1A to 1D include a zoom lens 1ZL in a lens barrel 11 and have a zoom function. In FIG. 1, the subject 2 is a sphere, but the subject 2 need not be a sphere. A ranging camera which does not specify any of the ranging cameras 1A to 1D is referred to as a ranging camera 1. The ranging camera 1 calculates a distance to a subject by irradiating light of, for example, a near-infrared wavelength from an infrared light source such as a vertical-cavity surface-emitting laser 13 (see FIG. 5A) and receiving the reflected light from the subject with a sensor.

The subject 2 may be surrounded by any number of cameras 1. The ranging camera 1 may be a TOF (Time of Flight) camera or a camera called a 3D scanner.

The ranging cameras 1A and 1C are arranged so that the lens barrels 11 are opposed to each other with the subject 2 arranged between the ranging camera 1A and the ranging camera 1C. The ranging cameras 1B and 1D are arranged so that the lens barrels 11 are opposed to each other with the subject 2 arranged between the ranging camera 1B and the ranging camera 1D. The distances from an unillustrated sensor in the ranging cameras 1A to 1D to a center 2c of the subject 2 are Da, Db, Dc, and Dd, respectively. Da to Dd are assumed to have the relationship Da>Dc>Db>Dd.

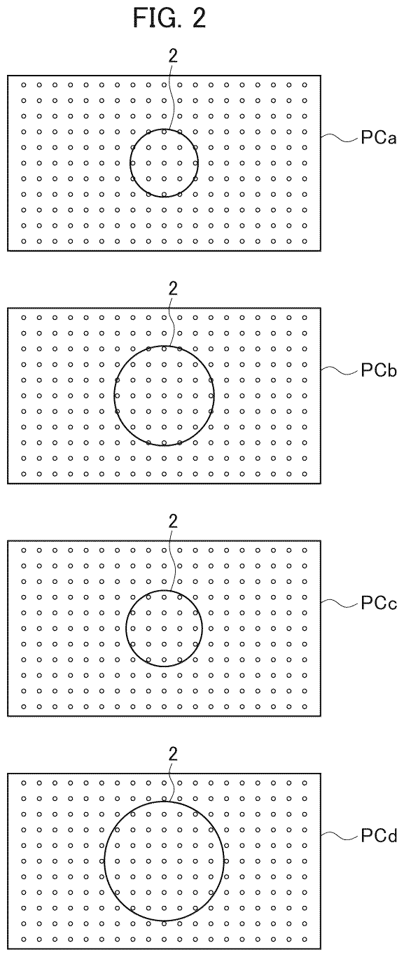

It is assumed that the zoom amounts of the ranging cameras 1A to 1D are the same. When distance data generated by the ranging cameras 1A to 1D are converted into point cloud data, point cloud data PCa to PCd corresponding to the ranging cameras 1A to 1D are conceptually shown as in FIG. 2. The size of the subject 2 in the point cloud data PCa to PCd is larger in the order of the point cloud data PCd, PCb, PCc, and PCa. Therefore, the amounts of the point clouds included in the subject 2 are different in the point cloud data PCa to PCd.

Visual discomfort may occur when the point cloud data PCa to PCd are synthesized to generate a volumetric image, which is a three-dimensional model of the subject 2. Therefore, each zoom amount needs to be individually adjusted for the ranging cameras 1A to 1D so that the size of the subject 2 is the same for each camera.

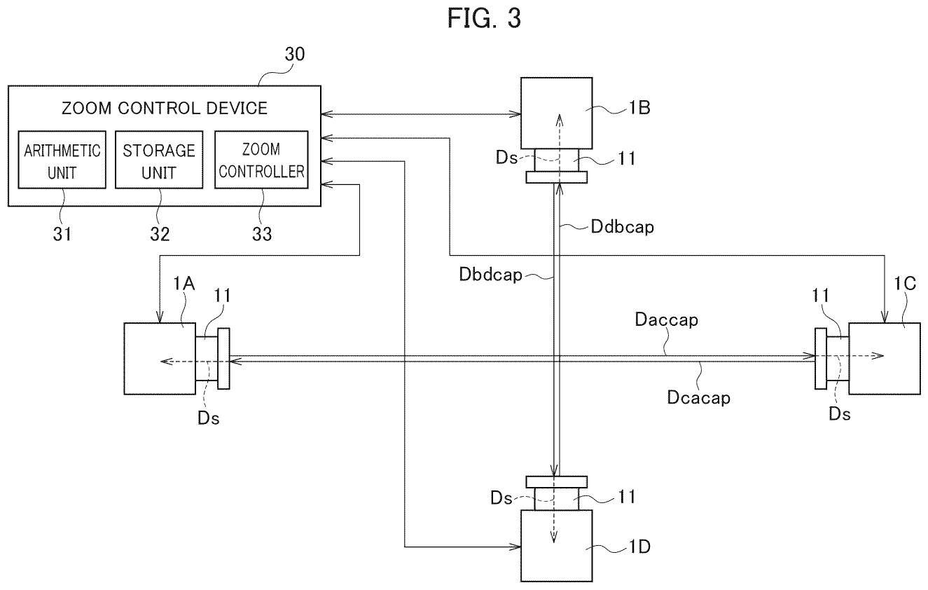

In FIG. 3, a zoom control device 30, which is a control device of a multi-ranging camera according to a first embodiment, includes an arithmetic unit 31, a storage unit 32, and a zoom controller 33. The zoom control device 30 may be constituted by a computing device such as a personal computer. As shown in FIG. 3, the subject 2 shown in FIG. 1 is temporarily moved to a desired position away from between the ranging camera 1A and the ranging camera 1C and between the ranging camera 1B and the ranging camera 1D.

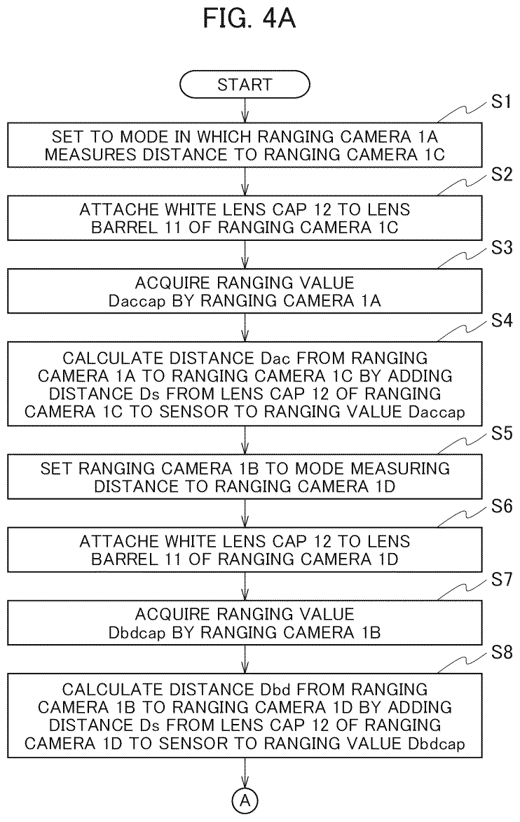

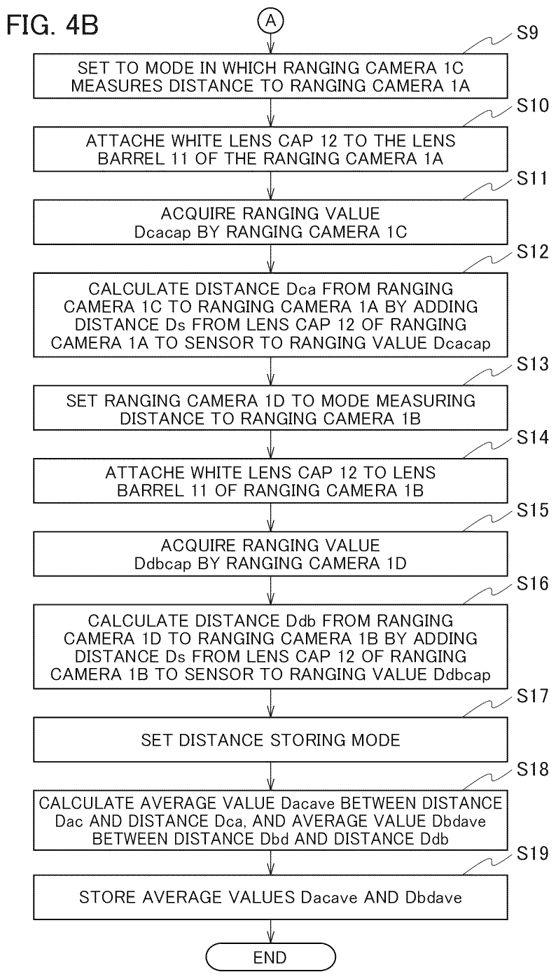

The zoom control device 30 measures a distance between the two ranging cameras 1 opposed to each other in the ranging cameras 1A to 1D in accordance with the flowchart shown in FIGS. 4A and 4B.

As shown in FIG. 4A, in step S1, the zoom control device 30 sets the ranging camera 1A to a mode in which the ranging camera 1A measures a distance to the ranging camera 1C. In step S2, a user attaches a white lens cap 12 to the lens barrel 11 of the ranging camera 1C. FIG. 5A is a plan view of a lens barrel 11 of the ranging camera 1 viewed from the front. At a tip of the lens barrel 11, for example, four vertical-cavity surface-emitting lasers (VCSEL) 13 are provided around the lens 11L. The VCSEL 13 emits near-infrared light. As shown in FIG. 5B, the user attaches the lens cap 12 to cover the lens 11 L of the ranging camera 1 C.

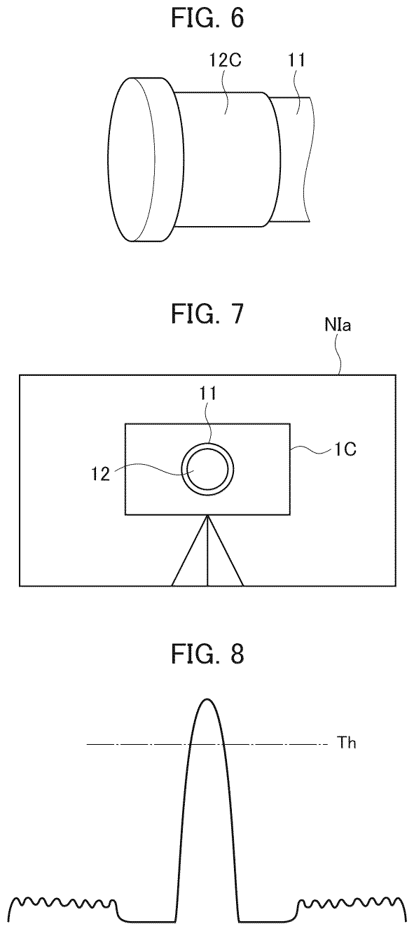

As shown in FIG. 5C, the user may attach to the lens barrel 11 of the ranging camera 1 the lens cap 12B with a center part 12B1 including an optical axis in white and a surrounding part 12B2 in black. As shown in FIG. 6, the user may attach a white lens cap 12C to cover an entire tip part of the lens barrel 11.

A housing of the ranging camera 1 including the lens barrel 11 is coated with a dark-colored paint such as black or gray, or a material itself has a dark color such as black or gray. Due to the low reflectance of the near-infrared light in a dark-colored subjects, ranging accuracy is deteriorated and a distance cannot be accurately measured when a ranging camera 1 measures a distance to an opposed ranging camera 1. If the lens cap 12, 12B, or 12C is attached to the lens barrel 11, the distance to the opposed ranging camera 1 can be accurately measured.

The lens cap 12, the center portion 12B1 of the lens cap 12B, and the lens cap 12C may be coated with a white paint or a material itself may be white. As the white paint, for example, a complex oxide pigment may be used for the purpose of shielding outdoor heat with high reflectance of near-infrared light. Hereinafter, it is assumed that the lens cap 12 is attached to the lens barrel 11.

In step S3, the zoom control device 30 controls the ranging camera 1A as follows to acquire a ranging value Daccap, which is the distance to the ranging camera 1C calculated by the ranging camera 1A. The ranging camera 1 adopts Indirect TOF (iToF) method and generates a near-infrared image simultaneously with a ranging image showing distance data as pixels. FIG. 7 conceptually shows a near-infrared image NIa generated by the ranging camera 1A photographing the ranging camera 1C. FIG. 8 shows the luminance level of near-infrared light in the horizontal direction at a vertical position through the lens cap 12 in the near-infrared image NIa.

The sensor of the ranging camera 1A receives the near infrared light emitted by the VCSEL 13 and reflected by the lens cap 12 attached to the lens barrel 11 of the ranging camera 1C. At this time, the zoom control device 30 stops the emission of the near infrared light by the VCSEL 13 in the ranging cameras 1B to 1D.

The zoom control device 30 controls the ranging camera 1A to generate the ranging value Daccap by taking an average value of only the ranging values in the area corresponding to the lens cap 12 that exceed the threshold value Th set by the zoom control device 30 for the near infrared image NIa. If the zoom control device 30 controls the ranging camera 1A in this way, the ranging camera 1A can accurately measure the distance to the tip of the lens barrel 11 of the ranging camera 1C. The zoom control device 30 acquires the ranging value Daccap generated by the ranging camera 1A in this way.

The zoom control device 30 may display the near-infrared image NIa on an unillustrated display by coloring areas in the near-infrared image NIa that exceed the threshold value Th in yellow, for example. By checking the areas colored in yellow in the near-infrared image NIa displayed on the display, a user can determine whether the ranging camera 1A generates the ranging value Daccap based on the ranging value in the area corresponding to the lens cap 12.

In step S4, the arithmetic unit 31 of the zoom control device 30 calculates a distance Dac from the ranging camera 1A to the ranging camera 1C by adding a distance Ds shown in FIG. 3 from the lens cap of the ranging camera 1C to the sensor to the ranging value Daccap. The distance Ds from the lens cap of the ranging camera 1 to the sensor is known, and stored in the storage unit 32 of the zoom control device 30 in advance.

In step S5, the zoom control device 30 sets the ranging camera 1B to a mode in which the ranging camera 1B measures a distance to the ranging camera 1D. In step S6, the user attaches a white lens cap 12 to the lens barrel 11 of the ranging camera 1D. In step S7, the zoom control device 30 controls the ranging camera 1B in the same way as it controls the ranging camera 1A, and acquires a ranging value Dbdcap which is a distance to the ranging camera 1D calculated by the ranging camera 1B. At this time, the zoom control device 30 stops the emission of near-infrared light from the VCSEL 13 in the ranging cameras 1A, 1C, and 1D.

In step S8, the arithmetic unit 31 of the zoom control device 30 calculates a distance Dbd from the ranging camera 1B to the ranging camera 1D by adding the distance Ds from the lens cap 12 of the ranging camera 1D to the sensor to the ranging value Dbdcap.

As shown in FIG. 4B, in step S9, the zoom control device 30 sets the ranging camera 1C to a mode in which the ranging camera 1C measures the distance to the ranging camera 1A. In step S10, the user attaches a white lens cap 12 to the lens barrel 11 of the ranging camera 1A. In step S11, the zoom control device 30 controls the ranging camera 1C in the same way as it controls the ranging camera 1A, and acquires a ranging value Dcacap which is a distance to the ranging camera 1A calculated by the ranging camera 1C. At this time, the zoom control device 30 stops the emission of near-infrared light from the VCSEL 13 in the ranging cameras 1A, 1B, and 1D.

In step S12, the arithmetic unit 31 of the zoom control device 30 calculates a distance Dca from the ranging camera 1C to the ranging camera 1A by adding the distance Ds from the lens cap 12 of the ranging camera 1A to the sensor to the ranging value Dcacap.

In step S13, the zoom control device 30 sets the ranging camera 1D to a mode in which the ranging camera 1D measures the distance to the ranging camera 1B. In step S14, the user attaches the white lens cap 12 to the lens barrel 11 of the ranging camera 1B. In step S15, the zoom control device 30 controls the ranging camera 1D in the same way as it controls the ranging camera 1A to acquire a ranging value Ddbcap which is a distance to the ranging camera 1B calculated by the ranging camera 1D. At this time, the zoom control device 30 stops the emission of near-infrared light from the VCSEL13 in the ranging cameras 1A, 1B, and 1C.

In step S16, the arithmetic unit 31 of the zoom control device 30 calculates the distance Ddb from the ranging camera 1D to the ranging camera 1B by adding the distance Ds from the lens cap 12 of the ranging camera 1B to the sensor to the ranging value Ddbcap.

In step S17, the zoom control device 30 sets the zoom control device 30 to a distance storing mode. In step S18, the arithmetic unit 31 of the zoom control device 30 calculates an average value Dacave between the distance Dac and the distance Dca, and an average value Dbdave between the distance Dbd and the distance Ddb. In step S19, the arithmetic unit 31 stores the average values Dacave and Dbdave in the storage unit 32, and ends the process.

Theoretically, the distance Dac and the distance Dca have the same value, and the distance Dbd and the distance Ddb have the same value. In practice, the ranging values by the ranging camera 1 include an error. By calculating the average value Dacave between the distance Dac and the distance Dca and the average value Dbdave between the distance Dbd and the distance Ddb, the accurate distance between the ranging camera 1A and the ranging camera 1C and the accurate distance between the ranging camera 1B and the ranging camera 1D can be acquired.

In this way, it is preferable to calculate the average value Dacave between the distance Dac and the distance Dca and the average value Dbdave between the distance Dbd and the distance Ddb. The process of measuring the distance between the ranging camera 1A and the ranging camera 1C may be simplified by calculating only the distance Dac or the distance Dca. The process of measuring the distance between the ranging camera 1B and the ranging camera 1D may be simplified by calculating only the distance Dbd or the distance Ddb.

As described above, the zoom control device 30 completes the measurement of the distance between the two ranging cameras 1 opposed to each other in the ranging cameras 1A to 1D and ends the mode of measuring the distance.

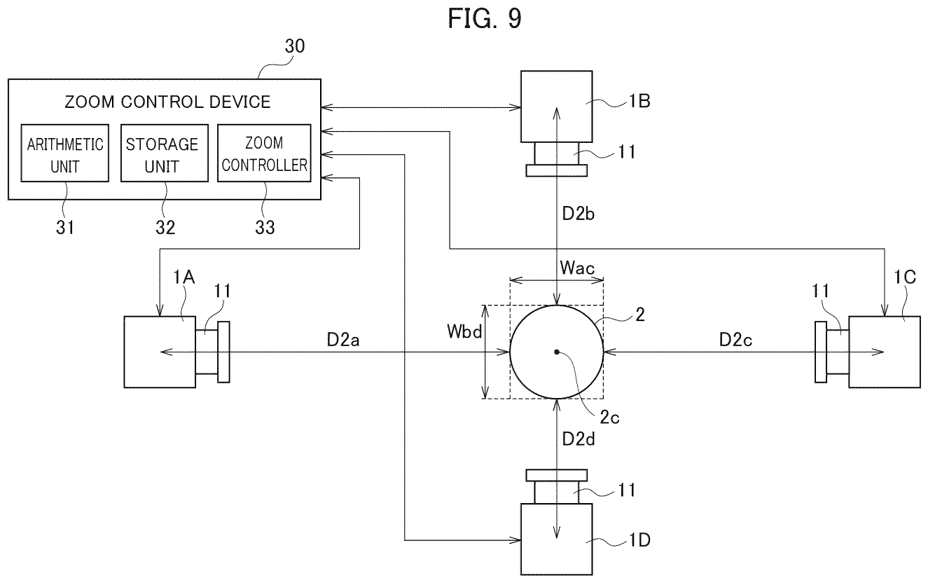

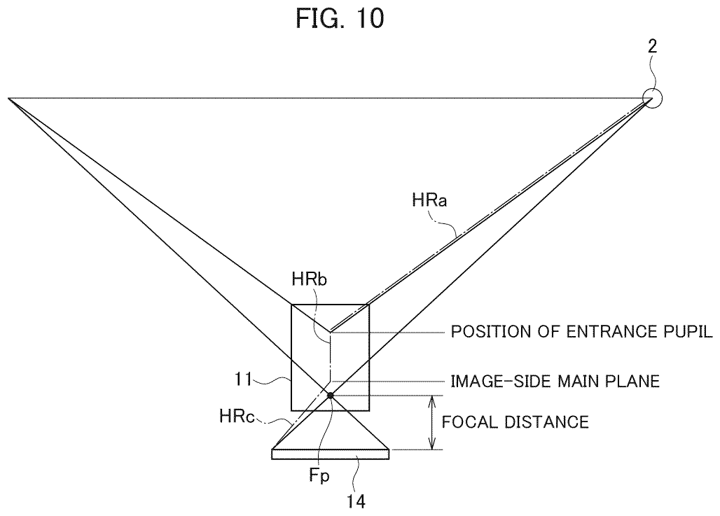

Subsequently, the zoom control device 30 shifts to a mode of photographing a subject 2. As shown in FIG. 9, the subject 2 shown in FIG. 1 is returned to a position between the ranging camera 1A and the ranging camera 1C, and between the ranging camera 1B and the ranging camera 1D. In FIG. 9, the zoom control device 30 acquires a distance D2a from the sensor of the ranging camera 1A to a surface of the subject 2 from the ranging camera 1A, and acquires a distance D2c from the sensor of the ranging camera 1C to the surface of the subject 2 from the ranging camera 1C. The zoom control device 30 acquires a distance D2b from the sensor of the ranging camera 1B to the surface of the subject 2 from the ranging camera 1B, and acquires a distance D2d from the sensor of the ranging camera 1D to the surface of the subject 2 from the ranging camera 1D.

The arithmetic unit 31 of the zoom control device 30 calculates a width Wac of the subject 2 in a direction connecting the ranging cameras 1A and 1C according to Equation (1), and a width Wbd of the subject 2 in a direction connecting the ranging cameras 1B and 1D according to Equation (2):

$$Wac = Dacave - D 2 a - D 2 c \qquad ( 1 )$$

$$Wbd = Dbdave - D 2 b - D 2 d . \qquad ( 2 )$$

The arithmetic unit 31 calculates the distances Da to Dd from the ranging cameras 1A to 1D to the center 2c of the subject 2 according to equations (3) to (6), respectively. The center 2c of the subject 2 is located at Wac/2 and Wbd/2.

$$Da = D 2 a + Wac / 2 \qquad ( 3 )$$

$$Db = D 2 b + Wbd / 2 \qquad ( 4 )$$

$$Dc = D 2 c + Wac / 2 \qquad ( 5 )$$

$$Dd = D 2 d + Wbd / 2 \qquad ( 6 )$$

The arithmetic unit 31 calculates distances Da to Dd for each frame of ranging images generated by the ranging cameras 1A to 1D. When the subject 2 is not a stationary object but a moving object, the arithmetic unit 31 may calculate distances Da to Dd when the subject 2 changes or moves.

Next, the user designates any of the ranging cameras 1 from the ranging cameras 1A to 1D as the reference ranging camera by the zoom control device 30. It is assumed that the user designates the ranging camera 1A as the reference ranging camera. The user sets the amount of zoom in the ranging camera 1A as desired by the zoom controller 33 of the zoom control device 30. FA indicates a focal length of the zoom in the ranging camera 1A.

The zoom controller 33 controls focal lengths FB to FD of the zoom in the ranging cameras 1B to 1D based on Equations (7) to (9), respectively. The zoom controller 33 supplies zoom control values to the ranging cameras 1B to 1D so that the zoom in the ranging cameras 1B to 1D can be adjusted to the focal lengths FB to FD shown in Equations (7) to (9):

$$FB = FA \times Da / Db \qquad ( 7 )$$

$$FC = FA \times Da / Dc \qquad ( 8 )$$

$$FD = FA \times Da / Dd . \qquad ( 9 )$$

Thus, when the user sets the focal length of the zoom of the ranging camera 1A as the reference ranging camera to FA, the zoom controller 33 controls the focal lengths FB to FD of the zoom in the ranging cameras 1B to 1D based on Equations (7) to (9), respectively. Since the amounts of zoom in the ranging cameras 1A to 1D are controlled according to the distances between the subject 2 and each of the ranging cameras 1, the subject 2 is photographed with approximately the same size by the ranging cameras 1A to 1D.

As a result, the angles of view almost coincide when the ranging cameras 1A to 1D photograph the subject 2, so that the amounts of point clouds in the photographed images by each ranging camera 1 almost coincide. Therefore, when the images photographed by the ranging cameras 1A to 1D are synthesized to generate a volumetric image, little visual discomfort occurs.

When the user changes the focal length of the zoom of the ranging camera 1A, the zoom controller 33 immediately controls the focal length of the zoom of the ranging cameras 1B to 1D to correspond to the change in the focal length of the ranging camera 1A. The amounts of the point clouds of the images photographed by the ranging cameras 1A to 1D almost coincide at any time, and a volumetric image with little visual discomfort can be generated.

However, there is a limit on the range within which the zoom lens 1ZL of the ranging camera 1 can move, so that the zoom control device 30 (zoom controller 33) needs to control the focal length of the zoom of the ranging cameras 1B to 1D within the range within which the zoom lens 1ZL can move. It is assumed that the zoom lens 1ZL of the ranging cameras 1A to 1D has the same performance, and the zoom lens 1ZL varies from a wide angle end to a telephoto end between the focal length W (mm) and T (mm).

When the ranging camera 1A is designated as the main camera, the largest distance greater than the distance Da among the distances Db to Dd is a maximum distance Dmax. When none of the distances Db to Dd is larger than the distance Da, the distance Da is the maximum distance Dmax. Among the distances Db to Dd, the smallest distance smaller than the distance Da is the minimum distance Dmin. When none of the distances Db to Dd is smaller than the distance Da, the distance Da is the minimum distance Dmin. When the focal length at the maximum distance Dmax is Fmax and the focal length at the minimum distance Dmin is Fmin, the focal lengths Fmax and Fmin are expressed by Equations (10) and (11), respectively.

$$Fmax = FA \times Dmax / Da \qquad ( 10 )$$

$$Fmin = FA \times Dmin / Da . \qquad ( 11 )$$

When a first condition is satisfied, in which the focal length Fmin is smaller than the focal length W and the focal length Fmax is smaller than the focal length T, the zoom control device 30 replaces the focal length FA in Equations (10) and (11) with the focal length Fa shown in Equation (12):

$$Fa = W \times W / Fmin . \qquad ( 12 )$$

When a second condition is satisfied, in which the focal length Fmin is larger than the focal length W and the focal length Fmax is larger than the focal length T, the zoom control device 30 replaces the focal length FA shown in Equations (10) and (11) with the focal length Fa shown in Equation (13):

$$Fa = T \times T / Fmax . \qquad ( 13 )$$

When a third condition is satisfied, in which the focal length Fmin is smaller than the focal length W, the focal length Fmax is larger than the focal length T, and the focal length FA is smaller than (T−W)/2+W, the zoom control device 30 replaces the focal length FA shown in Equations (10) and (11) with the focal length Fa shown in Equation (14):

$$Fa = W \times W / Fmin . \qquad ( 14 )$$

When a fourth condition is satisfied, in which the focal length Fmin is smaller than the focal length W, the focal length Fmax is larger than the focal length T, and the focal length FA is larger than (T−W)/2+W, the zoom control device 30 replaces the focal length FA in Equations (10) and (11) with the focal length Fa shown in Equation (15):

$$Fa = T \times T / Fmax . \qquad ( 15 )$$

If none of the first to fourth conditions is satisfied, the zoom control device 30 takes the focal length FA shown in equations (10) and (11) as the focal length Fa, as shown in equation (16):

$$Fa = FA . \qquad ( 16 )$$

The zoom control device 30 sets the focal length FA of the zoom of the ranging camera 1A to the focal length Fa shown in Equations (12) to (16). The zoom control device 30 replaces the focal length FA shown in Equations (7) to (9) with the focal length Fa shown in equations (12) to (16), and then calculates the focal lengths FB to FD of the ranging cameras 1B to 1D.

As described above, an arithmetic unit 31 of a zoom control device 30 calculates a distance from each ranging camera 1 of a plurality of ranging cameras 1 arranged to surround a subject 2 and including a zoom lens 1ZL to a center 2c of the subject 2.

The zoom controller 33 of the zoom control device 30 sets one of the plurality of ranging cameras 1 as a reference ranging camera 1. The zoom controller 33 controls a focal length of a zoom as described below when the ranging cameras 1 other than the reference ranging camera 1 photograph the subject 2. The zoom controller 33 obtains a focal length by multiplying the focal length of the zoom when the reference ranging camera 1 photographs the subject 2 by a value obtained by dividing a distance from the reference ranging camera 1 to the center 2c of the subject 2 by the distance from the ranging camera 1 other than the reference ranging camera 1 to the center 2c of the subject 2. The zoom controller 33 controls the zoom of the ranging cameras 1 other than the reference ranging camera 1 to be set to the focal length thus obtained.

By controlling the focal length of the zoom in the ranging cameras 1A to 1D within the movable range of the zoom lens 1ZL, the zoom control device 30 can approximately match the amounts of the point clouds of the photographed images by the ranging cameras 1A to 1D and generate a volumetric image with little visual discomfort.

### Second Embodiment

The control device and control method of the multi-ranging camera according to a second embodiment are suitable for use when it is impossible to temporarily move a subject photographed by a plurality of ranging cameras when adjusting each of the ranging cameras. If the subject cannot be temporarily moved, a distance between two opposed ranging cameras 1 such as the distances Dac, Dca, Dbd, and Ddb in a first embodiment cannot be calculated. The control device and control method of the multi-ranging camera according to a second embodiment are preferably used when the distance between two opposed ranging cameras 1 cannot be calculated.

The control device of the multi-ranging camera according to a second embodiment may include the zoom control device 30 shown in FIG. 3 or FIG. 9. In a second embodiment, the description of matters common to a first embodiment may be omitted. As shown in FIG. 9, the control device of the multi-ranging camera according to a second embodiment determines the center 2c of the subject 2 with the subject 2 arranged between the ranging cameras 1A to 1D as described below.

FIG. 10 shows in detail the ranging of the subject 2 by the ranging camera 1. FIG. 10 shows only the lens barrel 11 simplified into a rectangular shape and a sensor 14 in the ranging camera 1. A ranging value by the ranging camera 1 is expressed by a sum of a distance HRa from a surface of the subject 2 to a position of an entrance pupil, a distance HRb from the position of the entrance pupil to an image-side main plane, and a distance HRc from the image-side main plane to the sensor 14, indicated by a dash-dot line. FIG. 10 illustrates the near-infrared light incident on a left end of the sensor 14. When converting distance data into point cloud data, the ranging camera 1 generates a point cloud represented by (x, y, z) coordinates with the position of the focal distance from the surface of the sensor 14 to the focal point Fp as an origin.

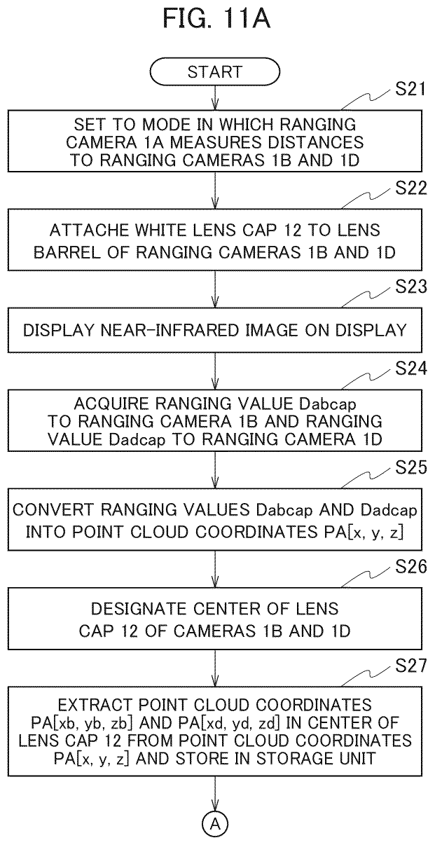

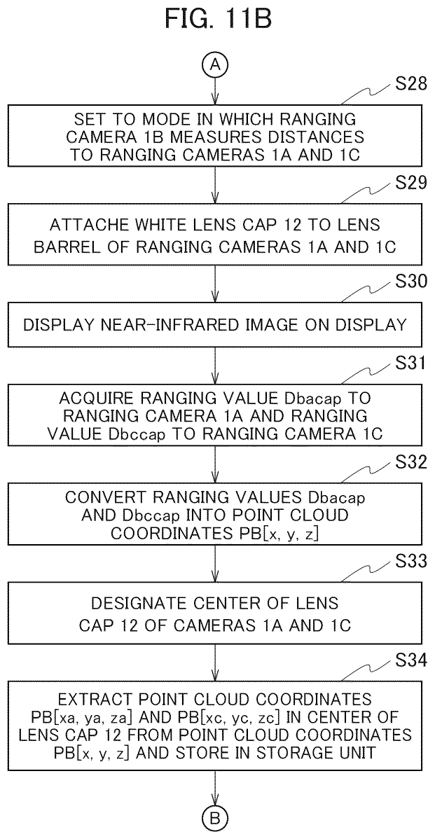

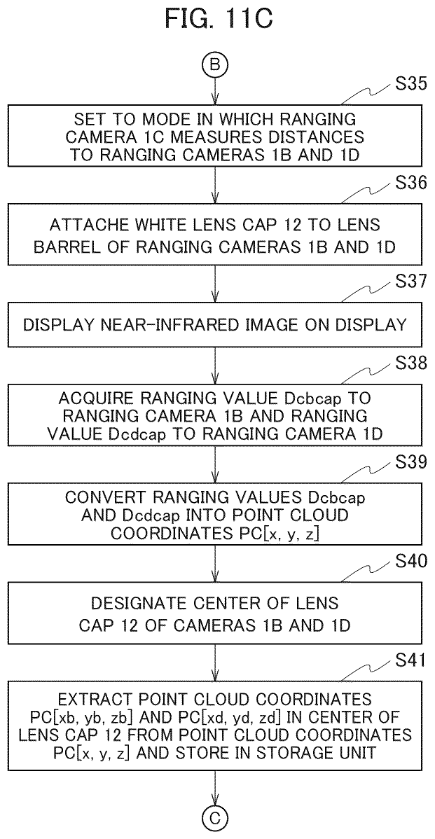

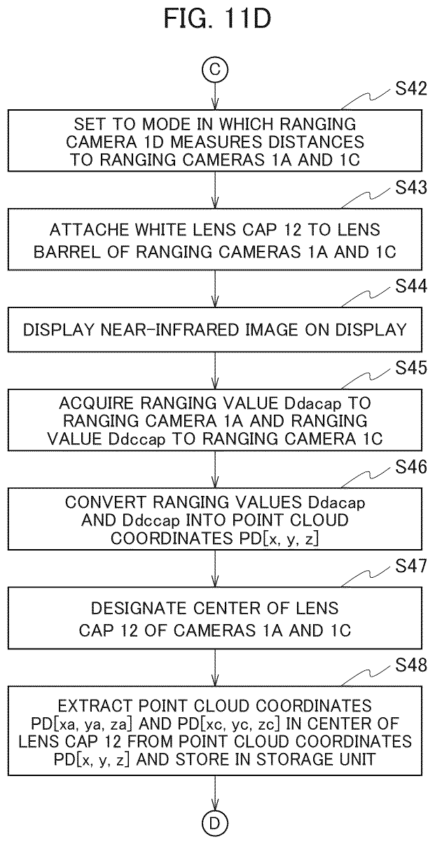

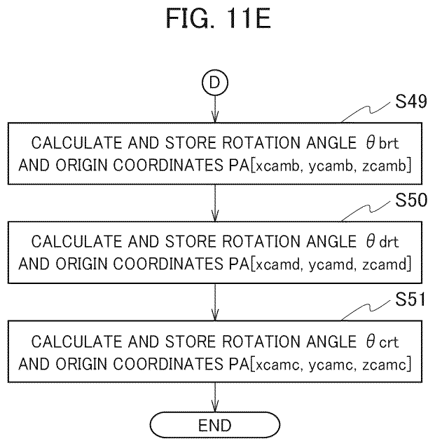

The zoom control device 30, which is the control device of the multi-ranging camera according to a second embodiment, measures the distance to the two adjacent ranging cameras 1 in a global space represented by (x, y, z) coordinates, instead of the opposed ranging cameras 1, according to the flowchart shown in FIGS. 11A to 11E.

As shown in FIG. 11A, in step S21, the zoom control device 30 sets the ranging camera 1A to a mode in which the ranging camera 1A measures distances to the ranging cameras 1B and 1D. The zoom control device 30 causes the VCSEL 13 in the ranging camera 1A to emit near-infrared light, and stops emission of near-infrared light from the VCSEL 13 in the ranging cameras 1B to 1D.

In step S22, a user attaches the white lens cap 12 to the lens barrel 11 of the ranging cameras 1B and 1D. In step S23, the zoom control device 30 displays a near-infrared image on a display. At this time, the zoom control device 30 may further display a ranging image and a point cloud image on the display.

In step S24, the zoom control device 30 acquires a ranging value Dabcap to the ranging camera 1B and a ranging value Dadcap to the ranging camera 1D. In step S25, the zoom control device 30 converts the ranging values Dabcap and Dadcap into the point cloud coordinates PA[x, y, z] corresponding to the ranging value Dabcap and the point cloud coordinates PA[x, y, z] corresponding to the ranging value Dadcap, respectively. In step S26, the user designates the center of the lens cap 12 by the cursor.

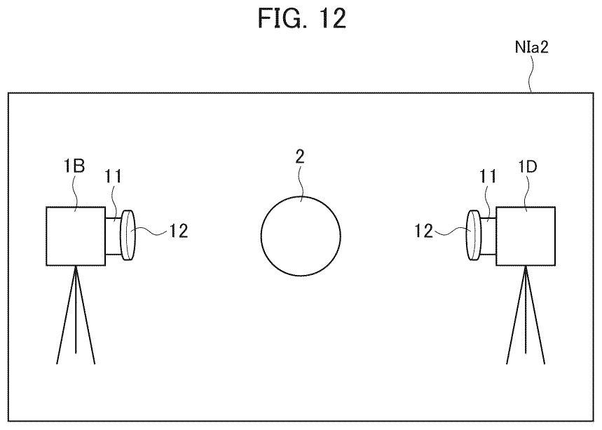

FIG. 12 shows a near-infrared image NIa2 displayed on the display in step S23. When a front face of the lens cap 12 is visible in the near-infrared image NIa2 as shown in FIG. 12, the user may specify the center of the lens cap 12 by the cursor in step S26. When the front face of the lens cap 12 is not visible in the near-infrared image NIa2 due to orientations of the ranging cameras 1B or 1D, the user may attach the lens cap 12C shown in FIG. 6 to the lens barrel 11 of the ranging cameras 1B or 1D in step S22. The user may specify the position of the lens cap 12 C corresponding to the center of the lens cap 12 by the cursor in step S26.

In step S27, the zoom control device 30 extracts the point cloud coordinates PA[xb, yb, zb] and PA[xd, yd, zd] in the center of the lens cap 12 from the point cloud coordinates PA[x, y, z] and stores them in the storage unit 32.

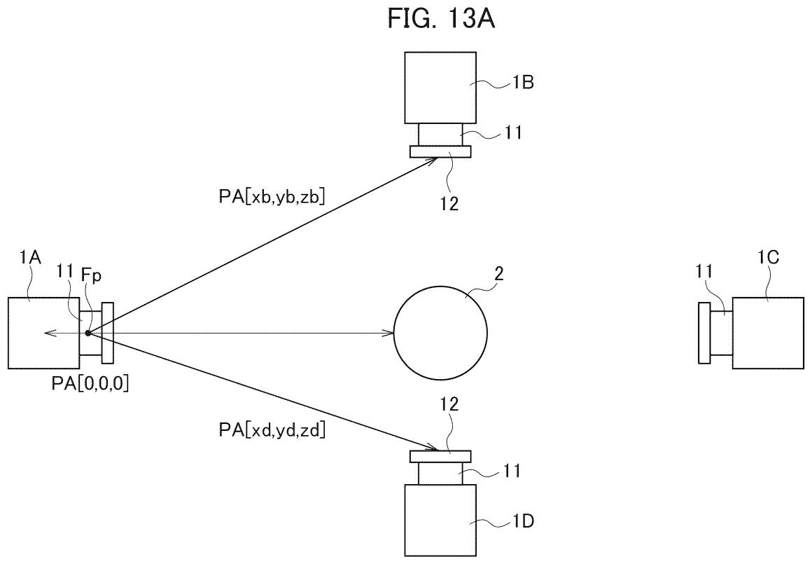

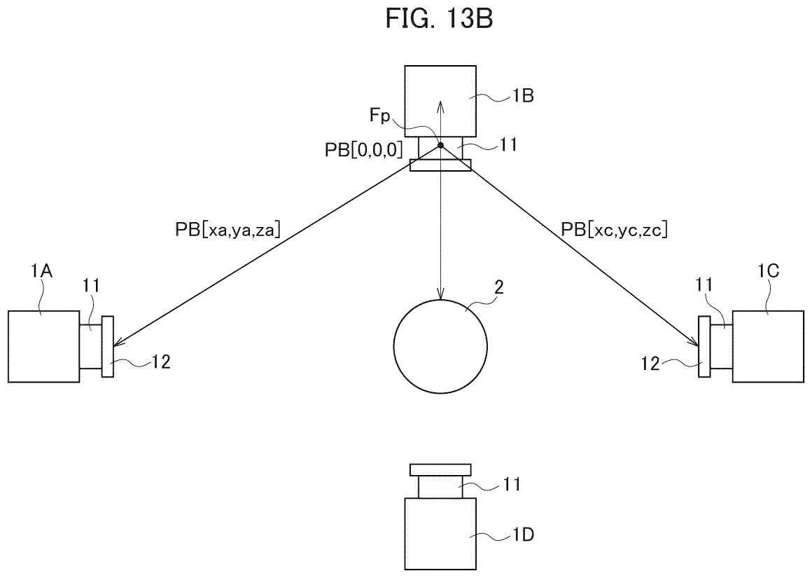

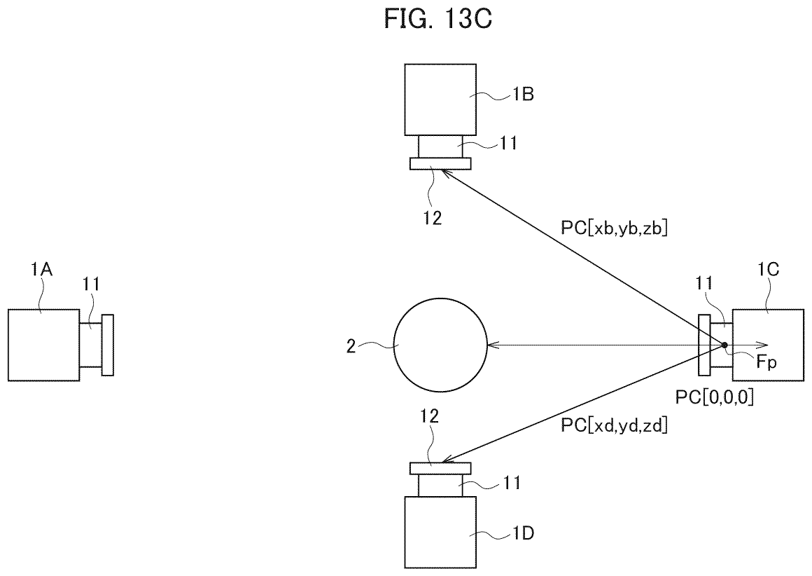

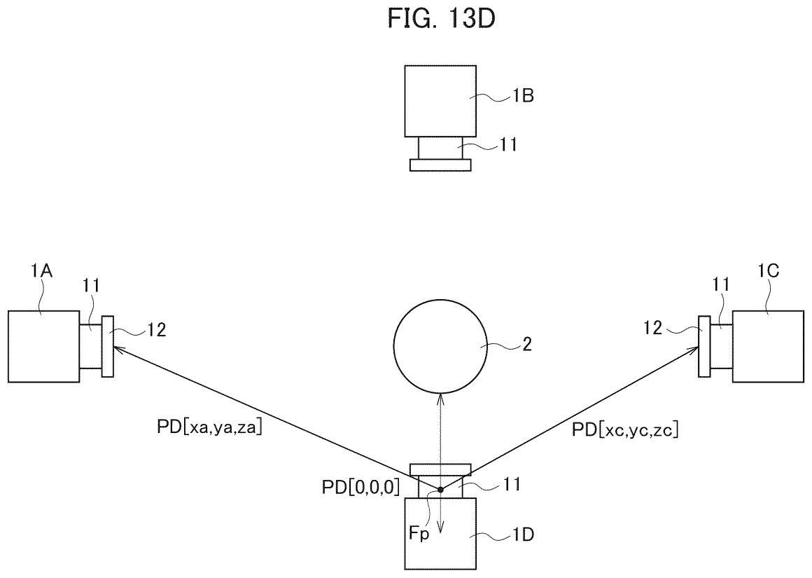

FIG. 13A shows the point cloud coordinates PA[xb, yb, zb] and PA[xd, yd, zd] extracted by the zoom control device 30 in step S27. When the point cloud coordinate of the focal point Fp in the ranging camera 1A is an origin coordinate PA[0, 0, 0], the point cloud coordinate PA[xb, yb, zb] indicates the distance from the origin coordinate PA[0, 0, 0] to the lens cap 12 of the ranging camera 1B, and the point cloud coordinate PA[xd, yd, zd] indicates the distance from the origin coordinate PA[0, 0, 0] to the lens cap 12 of the ranging camera 1D.

Following step S27, as shown in FIG. 11B, in step S28, the zoom control device 30 sets the ranging camera 1B to a mode in which the ranging camera 1B measures distances to the ranging cameras 1A and 1C. The zoom control device 30 causes the VCSEL 13 in the ranging camera 1B to emit near-infrared light, and stops emission of near-infrared light from the VCSEL 13 in the ranging cameras 1A, 1C, and 1D.

In step S29, the user attaches a white lens cap 12 to the lens barrel 11 of the ranging cameras 1A and 1C. In step S30, the zoom control device 30 displays a near-infrared image on the display. At this time, the zoom control device 30 may further display a ranging image and a point cloud image on the display. In step S29, depending on the orientation of the ranging camera 1A or 1C, the lens cap 12C may be attached to the lens barrel 11 instead of the lens cap 12.

In step S31, the zoom control device 30 acquires a ranging value Dbacap to the ranging camera 1A and a ranging value Dbccap to the ranging camera 1C. In step S32, the zoom control device 30 converts the ranging values Dbacap and Dbccap into point cloud coordinates PB[x, y, z] corresponding to the ranging value Dbacap and point cloud coordinates PB[x, y, z] corresponding to the ranging value Dbccap, respectively. The user designates the center of the lens cap 12 by the cursor in step S33.

In step S34, the zoom control device 30 extracts the point cloud coordinates PB[xa, ya, za] and PB[xc, yc, zc] in the center of the lens cap 12 from the point cloud coordinates PB[x, y, z] and stores them in the storage unit 32.

FIG. 13B shows the point cloud coordinates PB[xa, ya, za] and PB[xc, yc, zc] extracted by the zoom control device 30 in step S34. When the point cloud coordinate of the focal point Fp in the ranging camera 1B is an origin coordinate PB[0,0, 0], the point cloud coordinate PB[xa, ya, za] indicates the distance from the origin coordinate PB[0, 0, 0] to the lens cap 12 of the ranging camera 1A, and the point cloud coordinate PB[xc, yc, zc] indicates the distance from the origin coordinate PB[0,0, 0] to the lens cap 12 of the ranging camera 1C.

Following step S34, as shown in FIG. 11C, in step S35, the zoom control device 30 sets the ranging camera 1C to a mode in which the ranging camera 1C measures distances to the ranging cameras 1B and 1D. The zoom control device 30 causes the VCSEL 13 in the ranging camera 1C to emit near-infrared light, and stops emission of near-infrared light from the VCSEL 13 in the ranging cameras 1A, 1B, and 1D.

In step S36, the user attaches a white lens cap 12 to the lens barrel 11 of the ranging cameras 1B and 1D. In step S37, the zoom control device 30 displays a near-infrared image on the display. At this time, the zoom control device 30 may further display a ranging image and a point cloud image on the display. In step S36, depending on the orientation of the ranging camera 1B or 1D, the lens cap 12C may be attached to the lens barrel 11 instead of the lens cap 12.

In step S38, the zoom control device 30 acquires the ranging value Dcbcap to the ranging camera 1B and the ranging value Dcdcap to the ranging camera 1D. In step S39, the zoom control device 30 converts the ranging values Dcbcap and Dcdcap into the point cloud coordinates PC[x, y, z] corresponding to the ranging value Dcbcap and the point cloud coordinates PC[x, y, z] corresponding to the ranging value Dcdcap, respectively. In step S40, the user designates the center of the lens cap 12 by the cursor.

In step S41, the zoom control device 30 extracts the point cloud coordinates PC[xb, yb, zb] and PC[xd, yd, zd] in the center of the lens cap 12 from the point cloud coordinates PC[x, y, z] and stores them in the storage unit 32.

FIG. 13 C shows the point cloud coordinates PC[xb, yb, zb] and PC[xd, yd, zd] extracted by the zoom control device 30 in step S41. When the point cloud coordinate of the focal point Fp in the ranging camera 1C is set to an origin coordinate PC[0, 0, 0], the point cloud coordinate PC[xb, yb, zb] indicates the distance from an origin coordinate PC[0, 0, 0] to the lens cap 12 of the ranging camera 1B, and the point cloud coordinate PC[xd, yd, zd] indicates the distance from the origin coordinate PC[0, 0, 0] to the lens cap 12 of the ranging camera 1D.

Following step S41, as shown in FIG. 11D, in step S42, the zoom control device 30 sets the ranging camera 1D to a mode in which the ranging camera 1D measures distances to the ranging cameras 1A and 1C. The zoom control device 30 causes the VCSEL 13 in the ranging camera 1D to emit near-infrared light, and stops emission of near-infrared light from the VCSEL 13 in the ranging cameras 1A to 1C.

In step S43, the user attaches a white lens cap 12 to the lens barrel 11 of the ranging cameras 1A and 1C. In step S44, the zoom control device 30 displays a near-infrared image on the display. At this time, the zoom control device 30 may further display a ranging image and a point cloud image on the display. In step S42, depending on the orientation of the ranging camera 1A or 1C, the lens cap 12C may be attached to the lens barrel 11 instead of the lens cap 12.

In step S45, the zoom control device 30 acquires a ranging value Ddacap to the ranging camera 1A and a ranging value Ddccap to the ranging camera 1C. In step S46, the zoom control device 30 converts the ranging values Ddacap and Ddccap into the point cloud coordinates PD[x, y, z] corresponding to the ranging value Ddacap and the point cloud coordinates PD[x, y, z] corresponding to the ranging value Ddccap, respectively. In step S47, the user designates the center of the lens cap 12 by the cursor.

In step S48, the zoom control device 30 extracts the point cloud coordinates PD[xa, ya, za] and PD[xc, yc, zc] in the center of the lens cap 12 from the point cloud coordinates PD[x, y, z] and stores them in the storage unit 32.

FIG. 13D shows the point cloud coordinates PD[xa, ya, za] and PD[xc, yc, zc] extracted by the zoom control device 30 in step S48. When the point cloud coordinate of the focal point Fp in the ranging camera 1D is set to an origin coordinate PD[0, 0, 0], the point cloud coordinate PD[xa, ya, za] indicates the distance from the origin coordinate PD[0, 0, 0] to the lens cap 12 of the ranging camera 1A, and the point cloud coordinate PD[xc, yc, zc] indicates the distance from the origin coordinate PD[0, 0, 0] to the lens cap 12 of the ranging camera 1C.

Following step S48, as shown in FIG. 11E, in step S49, the arithmetic unit 31 of the zoom control device 30 calculates a rotation angle θbrt and an origin coordinate PA[xcamb, ycamb, zcamb] described below and stores them in the storage unit 32. In step S50, the arithmetic unit 31 calculates a rotation angle θdrt and an origin coordinate PA[xcamd, ycamd, zcamd] described below and stores them in the storage unit 32. In step S51, the arithmetic unit 31 calculates a rotation angle θcrt and an origin coordinate PA[xcamc, ycamc, zcamc] described below and stores them in the storage unit 32, and ends the process.

Which ranging cameras 1 among the ranging cameras 1A to 1D is used as a reference is optional and is not limited to using ranging camera 1A as a reference.

The processes of steps $49 to S51 will be specifically described. The point cloud coordinates PA[xb, yb, zb] and PA[xd, yd, zd], PB[xa, ya, za] and PB[xc, yc, zc], PC[xb, yb, zb] and PC[xd, yd, zd], as well as PD[xa, ya, za] and PD[xc, yc, zc] extracted by the zoom control device 30 are the local point cloud coordinates of each ranging camera 1. Therefore, in steps S49 to S51, the arithmetic unit 31 converts the point cloud coordinates measured by the distance measuring camera 1 other than the reference ranging camera 1 into global coordinates.

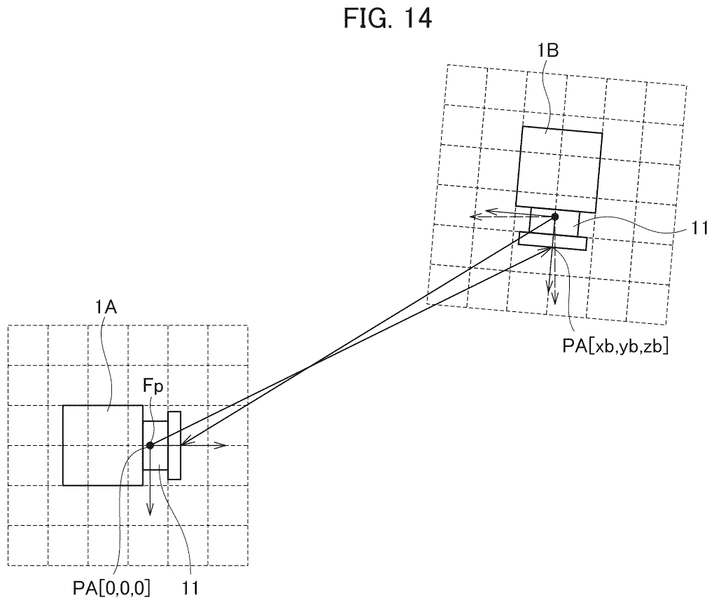

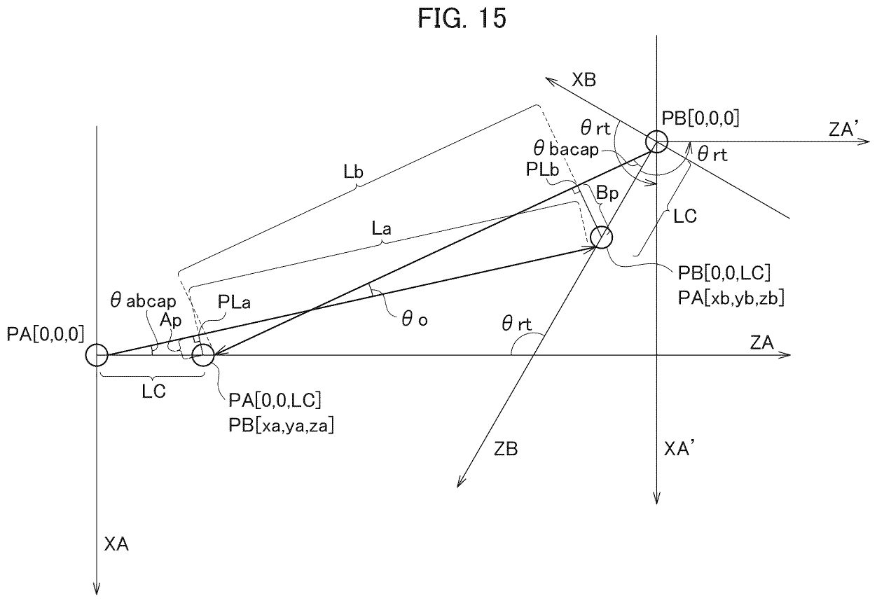

The conversion of the point cloud coordinates into global coordinates will be specifically described with reference to FIGS. 14 and 15. As shown in FIG. 14, the coordinates of the ranging camera 1B become coordinates at an angle as viewed from the ranging camera 1A when the ranging camera 1B is installed at an angle to the ranging camera 1A rather than at a right angle. Therefore, the coordinate system of the ranging camera 1B does not coincide with the coordinate system of the ranging camera 1A.

FIG. 15 is a diagram modeled on FIG. 14. With reference to FIG. 15, a method for converting the orientation of the point cloud coordinates PB[xa, ya, za] and PB[xc, yc, zc] by the ranging camera 1B into the orientation of the coordinate system of the point cloud coordinates PA[xb, yb, zb] and PA[xd, yd, zd] by the ranging camera 1A will be described.

In FIG. 15, an axis ZA is a direction of optical axis of the ranging camera 1A starting from the origin coordinate PA[0, 0, 0] of the ranging camera 1A, and a horizontal direction of the ranging camera 1A as well as a direction orthogonal to the axis ZA is defined as an axis XA. The distance from the origin coordinate PA[0, 0, 0] of the ranging camera 1A to the lens cap 12 is defined as LC. The distance LC is known. An axis ZB is a direction of an optical axis of the ranging camera 1B starting from the origin coordinate PB[0, 0, 0] of the ranging camera 1B, and an axis XB is a horizontal direction of the ranging camera 1B as well as a direction perpendicular to the axis ZB. The distance from the origin coordinate PB[0, 0, 0] of the ranging camera 1B to the lens cap 12 is set to LC as same as the distance LC from the origin coordinate PA[0, 0, 0] of the ranging camera 1A to the lens cap 12.

The point cloud coordinate of the local lens cap 12 of the ranging camera 1A is PA[0, 0, LC], and the point cloud coordinate of the lens cap 12 of the ranging camera 1A according to the local point cloud coordinate of the ranging camera 1B is PB[xa, ya, za]. The point cloud coordinate of the local lens cap 12 of the ranging camera 1B is PB[0, 0, LC], and the point cloud coordinate of the lens cap 12 of the ranging camera 1B according to the local point cloud coordinate of the ranging camera 1A is PA[xb, yb, zb].

Here, the point cloud coordinate on the axes XA and ZA, and an unillustrated axis YA that is orthogonal to the axes XA and ZA in FIG. 15 is a global coordinate with reference to the point cloud coordinate of the ranging camera 1A. An axis passing through the origin coordinate PB[0, 0, 0] parallel to the axis XA is an axis XA′, and an axis passing through the origin coordinate PB[0, 0, 0] parallel to the axis ZA is an axis ZA′. The axis XA′ is an axis obtained by rotating the axis XB by an angle θrt, and the axis ZA′ is an axis obtained by rotating the axis ZB by an angle θrt.

If the point cloud coordinates of the ranging camera 1B are rotated by an angle θrt on both the axes XB and ZB, and the origin coordinate PB[0, 0, 0] is changed to the origin coordinate PA[0, 0, 0], the point cloud coordinates PB[xa, ya, za] and PB[xc, yc, zc] based on the near-infrared image NIa2 of the ranging camera 1B can be expressed in global coordinates with reference to the point cloud coordinates of the ranging camera 1A.

The zoom control device 30 obtains the angle θrt in a following way. The angle formed by the axis ZA and the straight line from the origin coordinate PA[0, 0, 0] of the ranging camera 1A to the lens cap 12 of the ranging camera 1B is θabcap. The angle formed by the axis ZB and the straight line from the origin coordinate PB[0, 0, 0] of the ranging camera 1B to the lens cap 12 of the ranging camera 1A is θbacap. The angles θabcap and θbacap are obtained by the following Equations (17) and (18).

$$θ abcap = arctan ( - PA [ xb ] / PA [ zb ] ) \qquad ( 17 )$$

$$θ bacap = arctan ( PB [ xa ] / PB [ za ] ) . \qquad ( 18 )$$

When θo is an angle at the intersection of a straight line from the origin coordinate PA[0, 0, 0] of the ranging camera 1A to the lens cap 12 of the ranging camera 1B and a straight line from the origin coordinate PB[0, 0, 0] of the ranging camera 1B to the lens cap 12 of the ranging camera 1A, the angle θrt is expressed by the following Equation (19) with the angle θabcap and the angle θbacap and the angle θo.

$$\begin{matrix}θ rt = 180 - θ abcap - ( 180 - ( 180 - ( θ bacap + θ o ) ) ) \\ = 180 - θ abcap - θ bacap - θ o .\end{matrix} \qquad ( 19 )$$

The angle θo can be obtained in a following way. The point PLa is a position in which a straight line starting from the origin coordinate PA[0, 0, 0] of the ranging camera 1A is orthogonal to a straight line from the position of the lens cap 12 of the ranging camera 1A to the lens cap 12 of the ranging camera 1B. The distance from the point PLa to the position of the lens cap 12 of the ranging camera 1A is Ap, and the distance from the point PLa to the lens cap 12 of the ranging camera 1B is La. The point PLb is a position in which a straight line starting from the origin coordinate PB[0, 0, 0] of the ranging camera 1B is orthogonal to a straight line from the position of the lens cap 12 of the ranging camera 1B to the lens cap 12 of the ranging camera 1A. The distance from the point PLb to the lens cap 12 of the ranging camera 1B is Bp, and the distance from the point PLb to the lens cap 12 of the ranging camera 1A is Lb.

The distance Ap and the distance Bp are obtained by the following Equations (20) and (21):

$$Ap = LC ( sin θ abcap ) \qquad ( 20 )$$

$$Bp = LC ( sin θ bacap ) . \qquad ( 21 )$$

The distance La and the distance Lb are obtained by the following Equations (22) and (23).

$$La = \sqrt{{PA [ xb ]}^{2} + {PA [ zb ]}^{2}} - LC \times cos θ abcap . \qquad ( 22 )$$

$$Lb = \sqrt{{PB [ xa ]}^{2} + {PB [ za ]}^{2}} - LC \times cos θ bacap . \qquad ( 23 )$$

The angle do is obtained by the following Equations (24) or (25):

$$θ o = arctan ( Bp / ( Lb \times Bp / ( AP + Bp ) ) ) \qquad ( 24 )$$

$$θ o = arctan ( AP / ( La \times Ap / ( AP + Bp ) ) ) . \qquad ( 25 )$$

The distances La and Lb are calculated using the values of the X and Z axes of the point cloud coordinates PA[xb, yb, zb] and PB[xa, ya, za], respectively, and may include measurement errors due to noise or the like. Therefore, it is preferable that the angle do is the value obtained by averaging the angle θo calculated by Equation (24) and the angle θ0 calculated by Equation (25). The angle θrt is obtained by inputting the averaged angle θ0 into Equation (19).

Equation (26) is an arithmetic expression for converting the point cloud coordinates of the ranging camera 1B into global coordinates with reference to the point cloud coordinates of the ranging camera 1A by rotating the point cloud coordinates of the ranging camera 1B by the angle θrt on both axes XB and ZB.

$$\{ \begin{matrix}{x}^{′} \\ {y}^{′} \\ {z}^{′}\end{matrix} \} \begin{matrix}\begin{matrix}= \\ =\end{matrix} \\ =\end{matrix} \{ \begin{matrix}cos θ rt & 0 & sin θ rt \\ 0 & 1 & 0 \\ - sin θ rt & 0 & cos θ rt\end{matrix} \} \{ \begin{matrix}x \\ y \\ z\end{matrix} \} \qquad ( 26 )$$

x′, y′ and z′ obtained by inputting the point cloud coordinates PB[0, 0, LC] of the lens cap 12 of the ranging camera 1B to x, y and z in Equation (26) are set to the point cloud coordinates BCAP[xb′, yb′, zb′]. The point cloud coordinates BCAP[xb′, yb′, zb′] are global coordinates with reference to the ranging camera 1A. Looking at the origin coordinates PB[0, 0, 0] of the ranging camera 1B from the origin coordinates PA[0, 0, 0] of the ranging camera 1A, the origin coordinates PA[xcamb, ycamb, zcamb] of the ranging camera 1B take values obtained by vectorially subtracting the point cloud coordinates BCAP[xb′, yb′, zb′] from the point cloud coordinates PA[xb, yb, zb] as shown in Equation (27). The origin coordinates PA[xcamb, ycamb, zcamb] are global coordinates with reference to the ranging camera 1A.

$$PA [ xcamb , ycamb , zcamb ] = PA [ xb , yb , zb ] - BCAP [ {xb}^{′} , {yb}^{′} , {zb}^{′} ] . \qquad ( 27 )$$

The angle θrt shown in FIG. 15 is a rotation angle of local point cloud coordinates of the ranging camera 1B relative to local point cloud coordinates of the ranging camera 1A, and is referred to as an angle θbrt. The rotation angle of the local point cloud coordinates of the ranging camera 1D relative to the local point cloud coordinates of the ranging camera 1A is referred to as an angle θdrt. Similarly for the ranging camera 1D, the arithmetic unit 31 obtains the angle θdrt and obtains point cloud coordinates DCAP[xd′, yd′, zd′] and origin coordinates PA[xcamd, ycamd, zcamd] of the global coordinates with reference to the ranging camera 1A.

The rotation angle of the local point cloud coordinates of the ranging camera 1C relative to the local point cloud coordinates of the ranging camera 1A is referred to as an angle θcrt. For the ranging camera 1C, the zoom control device 30 obtains the point cloud coordinates CCAP[xc′, yc′, zc′] and the origin coordinates PA[xcamc, ycamc, zcamc] of the global coordinates with reference to the ranging camera 1A based on the point cloud coordinates BCAP[xb′, yb′, zb′] and the origin coordinates PA[xcamb, ycamb, zcamb] of the ranging camera 1B in the global coordinates.

First, the arithmetic unit 31 converts the point cloud coordinates PB[xc, yc, zc] of the lens cap 12 of the ranging camera 1C photographed by the ranging camera 1B into the global coordinates PA[xc, yc, zc] to which the ranging camera 1A refers. By obtaining the global coordinates PA[xc, yc, zc] by inputting the angle θbrt and the point cloud coordinates PB[xc, yc, zc] into Equation (26), the point cloud coordinates PB[xc, yc, zc] of the lens cap 12 of the ranging camera 1C can be converted into the global coordinates PA[xc, yc, zc] to which the ranging camera 1A refers.

Next, instead of PA in Equations (17) to (25), the origin coordinates PA[xcamb, ycamb, zcamb] are temporarily set to PA[0, 0, 0], and the positions PA[xb′-xcamb, yb′-ycamb, zb′-zcamb] of the lens cap 12 of the ranging camera 1B and the global coordinates PA[xc, yc, zc] of the ranging camera 1C photographed by the ranging camera 1B are inputted. Furthermore, the angle θcrt is obtained by inputting the point cloud coordinate PC[xb, yb, zb] of the lens cap 12 of the ranging camera 1B relative to the local origin coordinate PC[0, 0, 0] of the ranging camera 1C instead of PB in Equations (17) to (25).

The point cloud coordinates CCAP[xc′, yc′, zc′] are x′, y′, and z′ obtained by inputting the angle θcrt to Ort in Equation (26) and the point cloud coordinate PC[0, 0, LC] of the lens cap 12 of the ranging camera 1C to x, y, and z. As shown in Equation (28), the origin coordinate PA[xcamc-xcamb, ycamc-ycamb, zcamc-zcamb] is obtained by subtracting the global coordinate CCAP[xc′, yc′, zc′] of the lens cap 12 of the ranging camera 1C from the origin of the ranging camera 1C from the global coordinate PA[xc, yc, zc] of the lens cap 12 of the ranging camera 1C viewed from the ranging camera 1B.

$$PA [ xcamc - xcamb , ycamc - ycamb , zcamc - zcamb ] = PA [ xc , yc , zc ] - CCAP [ {xc}^{′} , {yc}^{′} , {zc}^{′} ] \qquad ( 28 )$$

The origin of the ranging camera 1B is temporarily set to [0, 0, 0] up to Equation (28). As shown in equation (29), in order to restore the origin, the origin coordinate PA[xcamc, ycamc, zcamc] of the ranging camera 1C is obtained by adding PA[xcamb, ycamb, zcamb] to Equation (28).

$$PA [ xcamc , ycamc , zcamc ] = PA [ xc , yc , zc ] - CCAP [ {xc}^{′} , {yc}^{′} , {zc}^{′} ] + PA [ xcamb , ycamb , zcamb ] \qquad ( 29 )$$

In order to improve the accuracy of the position of the ranging camera 1C, the arithmetic unit 31 may perform the following operation. The arithmetic unit 31 obtains the angle θcrt based on the point cloud coordinates DCAP[xb′, yb′, zb′] and the origin coordinates PA[xcamd, ycamd, zcamd] of the global coordinates. The arithmetic unit 31 obtains the point cloud coordinates CCAP[x, y, z] and the origin coordinates PA[xcamc, ycamc, zcamc] of the global coordinates with reference to the ranging camera 1A based on the coordinates of the ranging camera 1D.

The arithmetic unit 31 obtains the average of the point cloud coordinates CCAP[x, y, z] and the origin coordinates PA[xcamc, ycamc, zcamc] based on the coordinates of the ranging camera 1D and the point cloud coordinates CCAP[x, y, z] and the origin coordinates PA[xcamc, ycamc, zcamc] obtained based on the coordinates of the ranging camera 1B as described above. The arithmetic unit 31 sets the point cloud coordinates CCAP[x, y, z] and the origin coordinates PA[xcamc, ycamc, zcamc] of the obtained average values to the final point cloud coordinates CCAP[x, y, z] and the origin coordinates PA[xcamc, ycamc, zcamc].

As described above, the zoom control device 30 can obtain the rotation angles θbrt, θcrt, θdrt, the origin coordinate PA[xcamb, ycamb, zcamb] of the ranging camera 1B, the origin coordinate PA[xcamc, ycamc, zcamc] of the ranging camera 1C, and the origin coordinate PA[xcamd, ycamd, zcamd] of the ranging camera 1D with reference to the ranging camera 1A.

By using these values, the zoom control device 30 (arithmetic unit 31) converts the local point cloud coordinates PB[x, y, z], PC[x, y, z], and PD[x, y, z] of the ranging cameras 1B to 1D into the point cloud coordinate PA[x, y, z] of the global coordinates with reference to the ranging camera 1A.

In FIG. 13B, PB[xhb, yhb, zhb] is the local point cloud coordinate of the ranging camera 1B obtained by ranging the subject 2 by the ranging camera 1B. The arithmetic unit 31 obtains PA[x′hb, y′hb, z′hb] as x′, y′ and z′ by substituting angle θbrt for angle θrt in Equation (26) and point cloud coordinate PB[xhb, yhb, zhb] for x, y and z. The arithmetic unit 31 obtains the point cloud coordinate PA[x, y, z] of global coordinates with reference to the ranging camera 1A by vectorially adding the origin coordinate PA[xcamb, ycamb, zcamb] of the ranging camera 1B to PA[x′hb, y′hb, z′hb].

In FIG. 13C, PC[xhc, yhc, zhc] is the local point cloud coordinate of the ranging camera 1C obtained by ranging the subject 2 by the ranging camera 1C. The arithmetic unit 31 and obtains PA[x′hc, y′hc, z′hc] as x′, y′, and z′ by substituting the angle θcrt for the angle θrt in the Equation (26), and point cloud coordinates PC[xhc, yhc, zhc] for x, y, and z. The arithmetic unit 31 obtains the point cloud coordinates PA[x, y, z] of the global coordinates with reference to the ranging camera 1A by vectorially adding the origin coordinates PA[xcamc, ycamc, zcamc] of the ranging camera 1C to PA[x′hc, y′ hc, z′hc].

In FIG. 13D, PD[xhd, yhd, zhd] is the local point cloud coordinates of the ranging camera 1D obtained by ranging the subject 2 by the ranging camera 1D. The arithmetic unit 31 obtains PA[x′hd, y′hd, z′hd] as x′, y′, and z′ by substituting the angle θdrt for the angle θrt in Equation (26), and the point cloud coordinates PD[xhd, yhd, zhd] for x, y, and z. The arithmetic unit 31 obtains the point cloud coordinates PA[x, y, z] of the global coordinates with reference to the ranging camera 1A by vectorially adding the origin coordinates PA[xcamd, ycamd, zcamd] of the ranging camera 1D to PA[x′hd, y′ hd, z′ hd].

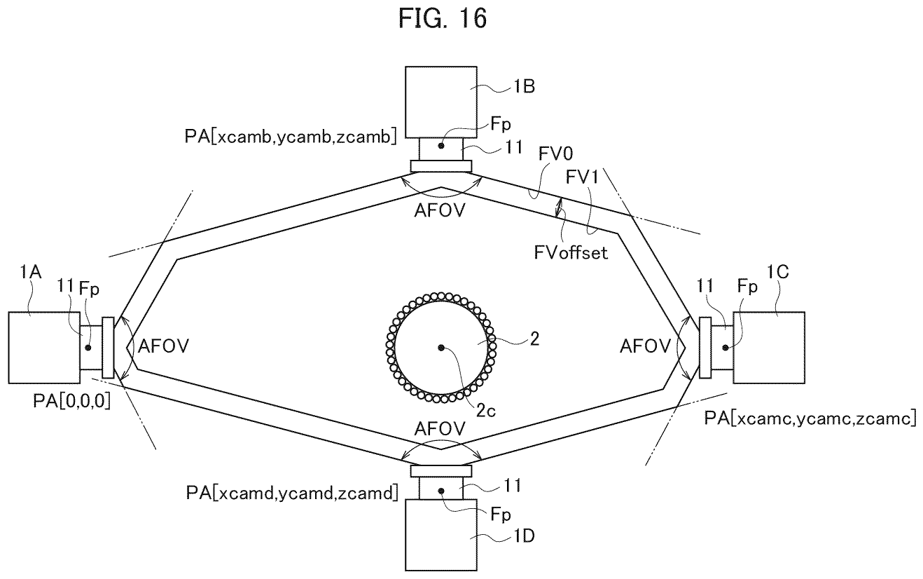

A method for obtaining the center 2c of the subject 2 will be described with reference to FIG. 16. The arithmetic unit 31 takes the average value of the point group coordinates

PA[x, y, z] in global coordinates with reference to the ranging camera 1A, which are made into a point group by ranging cameras 1A to 1D measuring the subject 2, as the coordinates PA[Hcx, Hcy, Hcz] indicating the centre 2c of the subject 2.

In FIG. 16, a viewing range FV0 is a range enclosed by an angle field of view (AFOV) which is a viewing angle of the ranging cameras 1A to 1D. An offset viewing range FV1 is a range in which the viewing range FV0 is offset inward by a distance FVoffset in a direction of axes XA and ZA, and the unillustrated axis YA orthogonal to the axes XA and ZA in FIG. 15. The arithmetic unit 31 preferably sets the average value of only the point cloud coordinates PA[x, y, z] by the ranging cameras 1A to 1D in an offset viewing range FV1 as a coordinate PA[Hcx, Hcy, Hcz] of the center 2c of the subject 2.

The arithmetic unit 31 obtains the respective distances Da to Dd from the coordinate PA[Hcx, Hcy, Hcz] of the center 2c of the subject 2 to the origin coordinates PA[xcamb, ycamb, zcamb], PA[xcamc, ycamc, zcamc], and PA[xcamd, ycamd, zcamd] of the ranging cameras 1A to 1D based on Equations (30) to (33).

$$Da = \sqrt{{Hcx}^{2} + {Hcy}^{2} + {Hcx}^{2}} \qquad ( 30 )$$

$$DB = \sqrt{{( Hcx - PA [ xcamb ] )}^{2} + {( Hcy - PA [ ycamb ] )}^{2} + ( Hcz - {PA ( [ zcamb ] )}^{2}} \qquad ( 31 )$$

$$Dc = \sqrt{{( Hcx - PA [ xcamc ] )}^{2} + {( Hcy - PA [ ycamc ] )}^{2} + ( Hcz - {PA ( [ zcamc ] )}^{2}} \qquad ( 32 )$$

$$Dd = \sqrt{{( Hcx - PA [ xcamd ] )}^{2} + {( Hcy - PA [ ycamd ] )}^{2} + ( Hcz - {PA ( [ zcamd ] )}^{2}} . \qquad ( 33 )$$

As described above, the zoom control device 30 (arithmetic unit 31) can obtain the distance Da to Dd from the ranging cameras 1A to 1D to the center 2c of the subject 2 even if the subject 2 remains surrounded by the ranging cameras 1A to 1D. The arithmetic unit 31 calculates the distance Da to Dd for each frame of the ranging images generated by the ranging cameras 1A to 1D. The arithmetic unit 31 may calculate the distances Da to Dd when the subject 2 changes or moves.

As in a first embodiment, the zoom control device 30 (zoom controller 33) controls the focal lengths FB to FD of the zoom of the ranging cameras 1B to 1D based on equations (7) to (16) when the user sets the focal length of the zoom of the ranging camera 1A, which is the reference ranging camera, to FA. The zoom controller 33 controls the focal length of the zoom of the ranging cameras 1A to 1D within the movable range of the zoom lens 1ZL.

In a second embodiment, the zoom controller 33 also controls the amounts of zoom in the ranging cameras 1A to 1D according to the distances between the subject 2 and each of the ranging cameras 1, so that the subject 2 is photographed at approximately the same size by the ranging cameras 1A to 1D. As a result, the angles of view almost coincide when the ranging cameras 1A to 1D photograph the subject 2, so that the amounts of the point clouds in the images photographed by each of the ranging cameras 1 almost coincide. Therefore, when the images photographed by the ranging cameras 1A to 1D are synthesized to generate a volumetric image, little visual discomfort occurs.

As described above, according to the control device and control method of the multi-ranging camera according to a first or a second embodiment, the amounts of point clouds in the images photographed by the ranging cameras can coincide even if a plurality of ranging cameras are arranged at different distances from the subject.

The present invention is not limited to a first or a second embodiment described above, and various modifications are possible within a scope not departing from a scope of the present invention.

What is claimed is:

1. A control device for a multi-ranging camera comprising:
an arithmetic unit configured to calculate a distance from each ranging camera of a plurality of ranging cameras arranged to surround a subject and including a zoom lens to a center of the subject; and
a zoom controller configured to set one of the plurality of ranging cameras as a reference ranging camera, and to control a zoom of the ranging cameras other than the reference ranging camera so that a focal length of a zoom when the ranging cameras other than the reference ranging camera photograph the subject is set to a focal length obtained by multiplying the focal length of the zoom when the reference ranging camera photographs the subject by a value obtained by dividing a distance from the reference ranging camera to the center of the subject by a distance from the ranging cameras other than the reference ranging camera to the center of the subject.

2. The control device for a multi-ranging camera according to claim 1, wherein
the arithmetic unit is configured to calculate a width of the subject in a direction of two opposed ranging cameras based on a distance between the two opposed ranging cameras among the plurality of ranging cameras and a distance from each ranging camera to a surface of the subject, and
to calculate a distance from each ranging cameras to the center of the subject based on the distance from each ranging cameras to the surface of the subject and the width of the subject.

3. The control device for a multi-ranging camera according to claim 1, wherein
the arithmetic unit is configured
to convert local origin coordinates of each of the ranging cameras and local point cloud coordinates of a distance to the subject measured by each of the ranging cameras to origin coordinates of global coordinates with reference to the reference ranging camera and point cloud coordinates indicating the distance to the subject,
to obtain the center of the subject based on an average value of the point cloud coordinates of the global coordinates indicating the distance to the subject by the plurality of ranging cameras, and
to calculate the distance from the center of the subject to the origin coordinate of the global coordinate of each of the ranging camera.

4. The control device for a multi-ranging camera according to claim 3, wherein
the arithmetic unit is configured convert the local origin coordinates of each of the ranging cameras and the local point cloud coordinates of a distance to the subject measured by each of the ranging cameras to the origin coordinates of the global coordinates and the point cloud coordinates indicating the distance to the subject.

5. A control method for multi-ranging camera comprising:
by means of a computing device that controls a plurality of ranging cameras arranged to surround a subject,
calculating a distance from each ranging camera of the plurality of ranging cameras to a center of the subject;
setting one of the plurality of ranging cameras as a reference ranging camera; and
controlling a zoom of the ranging cameras other than the reference ranging camera so that a focal length of a zoom when the ranging cameras other than the reference ranging camera photograph the subject is set to a focal length obtained by multiplying the focal length of the zoom when the reference ranging camera photographs the subject by a value obtained by dividing a distance from the reference ranging camera to the center of the subject by a distance from the ranging cameras other than the reference ranging camera to the center of the subject.
